(19) United States
(12) Patent Application Publication
(10) Pub. No.: US 2017/0169457 A1
(43) Pub. Date: Jun. 15, 2017

(54) System and Method for Providing Users with Products on a Time-Based Schedule Having No Price Bias

(71) Applicant: Hooch, Inc., New York, NY (US)

(72) Inventors: Lin Dai, New York, NY (US); Jared Christopherson, New York, NY (US); Aleksey Kernes, New York, NY (US); David Bella, New Milford, CT (US)

(21) Appl. No.: 15/376,194

(22) Filed: Dec. 12, 2016

Related U.S. Application Data
(60) Provisional application No. 62/266,204, filed on Dec. 11, 2015.

(51) Int. Cl. G06Q 30/02

(52) U.S. Cl. CPC G06Q 30/0211

(57) ABSTRACT

Exemplary embodiments herein provide a system and method for providing electronic product redemption approvals to produce sales analytics data without price bias. The method includes accepting a subscription payment from a user's smart device at a cloud based server, electronically providing the user with a plurality of tangible consumable products available from a plurality of businesses for redemption on the user's smart device within a present session, accepting an electronic redemption request from the user for a specific tangible consumable product redemption from a specific business, accepting an electronic approval for the electronic redemption request from an employee of the business selected for product redemption; and storing the redemption data at the cloud based server to produce sales analytics data without price bias.

### CROSS-REFERENCE TO RELATED APPLICATIONS

This application claims priority to U.S. Provisional Application No. 62/266,204 filed on Dec. 11, 2015 which is herein incorporated by reference in its entirety.

### TECHNICAL FIELD

Embodiments generally relate to systems and method for providing users with consumable product redemptions on a time-based schedule and producing sales analytical data without price bias.

### BACKGROUND OF THE ART

Businesses are constantly searching for new and innovative ways to engage with their customers. Traditional marketing and advertising methods are not as effective with today's consumers who spend less and less time consuming traditional media and participating in traditional coupon or sales programs. Even further, analytics have become one of the most useful tools for business owners to understand the behavior and preferences of their customers and help maximize profitability. The precise popularity of certain products can be difficult to determine due to the presence of price bias, and until the exemplary embodiments herein, it was difficult or impossible to remove this bias from the analytics or to build a product redemption system that was not affected by this bias. Generally speaking, price bias is understood as the preference of one product or service over another, not because the product or service is better or more desirable, but because based on its current price it is considered to be a better value or deal. This can shade the data regarding actual demand or interest in the product or service and how it compares to other similar products and services. This creates noise, which makes it harder to businesses to understand the impact of product discount systems or to simply understand which products and services are more desirable to customers.

Product coupon or discount systems of the past were generally focused on providing a specific deal on a specific item at a specific business and were available for a single use, where the business would then hope that the experience would cause the customer to return for another sale, but this time at regular price. Other systems may be focused on a general discount or deal at the business and not on a particular item, but these systems again struggle with the re-engagement of the customer and are still focused on a single business and not multiple businesses simultaneously. Further, systems of the past did not allow businesses to change their discount/coupon offerings on a daily basis as well as limiting the discount/coupon to specific products which can also change daily.

### SUMMARY OF THE EXEMPLARY EMBODIMENTS

It has been discovered that the discount systems of the past are not effective in the lives of modern consumers for a number of reasons. Ongoing engagement with the customer happened infrequently at best and was not trackable to create proper analytics. Further, any data that could be gathered was heavily shaded by the price bias. Various businesses, and specifically those engaged in consumable goods, would proceed independently of one another in an attempt to gather customers, when many of those businesses may have products that are attractive to the same customer groups. This is highly inefficient and creates a situation where businesses are spending more time and money to reach new customers than would otherwise be necessary if they were to pool their resources and efforts.

Exemplary embodiments provide a system and method for giving time-based product redemptions to users based on a fee paid to a third party, unrelated to the underlying businesses producing the products, and tracking the redemption data to produce insightful analytics. After paying a subscription fee to a third party, the user can obtain one product redemption within each session, which typically means one free tangible consumable product during each business day in exchange for a monthly (or annual) subscription fee paid to a third party. The businesses participating in the system can choose which products will be offered for redemption and on which days. The products being offered for redemption may or may not be currently offered for sale by the business through a traditional POS transaction. Thus, in some embodiments the products being offered for redemption are not available for purchase, and the redemption offerings are made to encourage patrons to visit the business or for research in determining which products are the most desirable.

When the product redemption is provided to the user, the user is given the product from the business free of charge. By then storing and tracking the redemption data, the actual preferences of various types of customers can finally be determined while limiting the impact of price bias on the resulting data and behavior patterns.

The foregoing and other features and advantages of the present invention will be apparent from the following more detailed description of the particular embodiments, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is block diagram showing how data would flow through the various components of an exemplary embodiment using a mobile smart device and a cloud server.

FIG. 2 is a logical flowchart showing the logic performed within an exemplary embodiment of the system.

FIG. 3 is block diagram showing how data would flow through the various components of an exemplary embodiment using a mobile smart device and a cloud server.

FIG. 4 is a logical flowchart showing how the logic within the cloud server would work for an exemplary embodiment.

FIG. 5 is a logical flowchart showing how the logic within the mobile device would work for an exemplary embodiment.

FIG. 6 is a screen shot from a mobile smart device showing a login page.

FIG. 7 is a screen shot from a mobile smart device showing a profile page.

FIG. 8 is a screen shot from a mobile smart device showing an account settings page.

FIG. 9 is a screen shot from a mobile smart device showing a plan and billing information page.

FIG. 10 is a screen shot from a mobile smart device showing a location searching page.

FIG. 11 is a screen shot from a mobile smart device showing a neighborhood geographical drop down menu page.

FIG. 12 is a screen shot from a mobile smart device showing a venue search page post subscription and redemption.

FIG. 13 is a screen shot from a mobile smart device showing a map view after redemption.

FIG. 14 is a screen shot from a mobile smart device showing a venue page.

FIG. 15 is a screen shot from a mobile smart device showing a sample drink description.

FIG. 16 is a screen shot from a mobile smart device showing a drink which has been selected for redemption.

FIG. 17 is a screen shot from a mobile smart device showing the employee prompt page after a drink has been selected for redemption by the user.

FIG. 18 is a screen shot from a mobile smart device showing the employee prompt page when using the optional employee code.

FIG. 19 is a screen shot from a mobile smart device where the employee is entering the employee code in order to redeem the drink for the user.

FIG. 20 is a screen shot from a mobile smart device showing the redemption page after the employee accepts the redemption request.

FIG. 21 is a screen shot from a mobile smart device where the user has requested a second drink within the same session.

FIG. 22 is a screen shot from a mobile device showing another redemption page after the employee has accepted the redemption request, here with the option of donating.

FIG. 23 is a graphical representation of the redemption data showing the popularity of various products based on sex and age of the customer and without price bias.

FIG. 24 is a graphical representation of the redemption data combined with user data showing the number of products redeemed during each hour of the day along with the average age of users redeeming a product during each hour of the day.

FIG. 25 is a graphical representation of the redemption data showing the total number of available redemptions at all businesses depending on the day of the week.

FIG. 26 is a graphical representation of the redemption data showing the total number of business that are offering redeemable products depending on day of the week.

FIG. 27 is a graphical representation of the redemption data showing the number of drink redemptions per drink number at each bar during the month of July.

FIG. 28 is a graphical representation of the redemption data showing the number of available products at Joe's bar depending on the day of the week when using a first time based product redemption system model.

FIG. 29 is a graphical representation of the redemption data showing the number of available products at Joe's bar depending on the day of the week when using a second time based product redemption system model.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

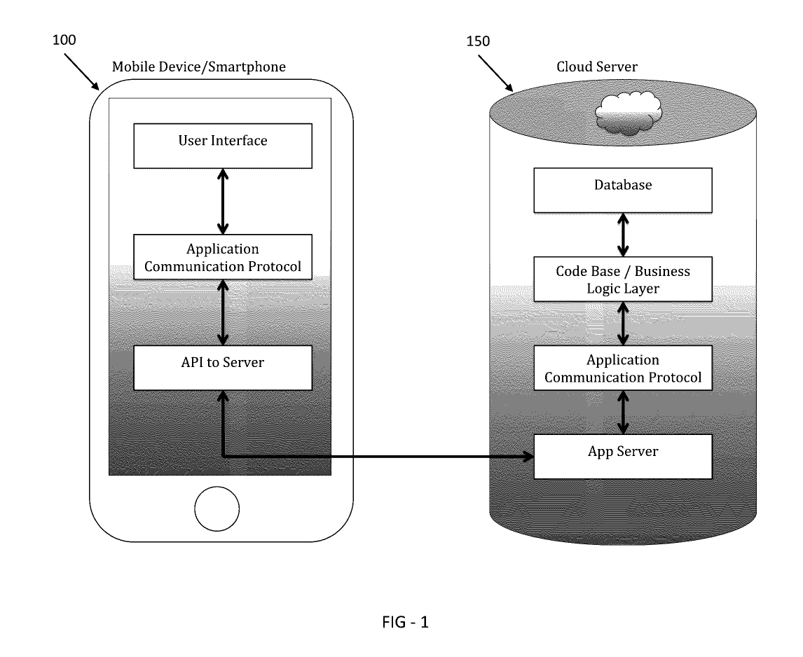

FIG. 1 is block diagram showing how the data and logic explained herein would flow through the various components of an exemplary embodiment using a mobile smart device 100 and a cloud server 150. In an exemplary version of the system there would be a plurality of smart devices 100 used along with multiple cloud servers 150 (if necessary).

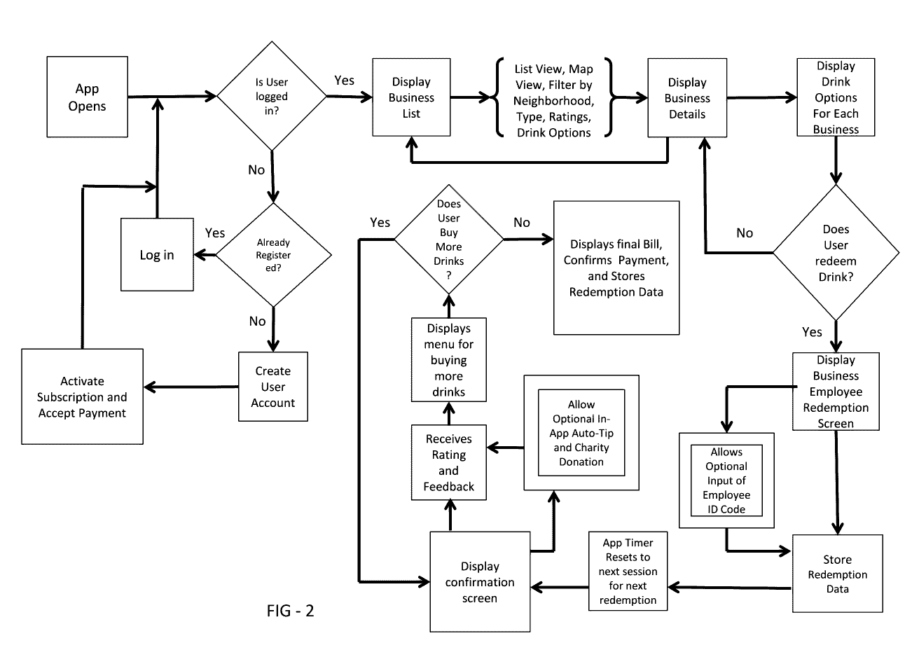

FIG. 2 is a logical flowchart showing the logic performed within an exemplary embodiment of the system. The user may be given a trial period with a limited number of redemptions, but following the trial period the user would be required to purchase a subscription which could be a payment that is made annually, monthly, or weekly. The subscription fee generally is paid to a third party that is not one of the businesses which provides redemptions, although in some embodiments a portion of the subscription fee could be shared with the businesses offering redemptions.

Once a user has purchased a subscription from the third party, the system allows a user to search venues and filter the various businesses through a map view, neighborhood, type of drink, ratings for the drink, or available drinks at each venue. The user can then select a drink for redemption, and once the redemption screen is shown to the employee for electronic approval of the redemption request (sometimes input of the employee ID code, biometric, magnetic strip, RFID chip, or a basic approval and swipe, etc.) the product can be redeemed.

As used herein, the term “redemption” or “redeeming a drink” is defined as the act of providing a tangible consumable product free of charge to a user at the time of providing, where the user has previously paid a subscription fee to a third party. During a redemption, the point-of-sale (POS) system of the business providing the redemption is preferably not engaged (although this is not required). It is preferred that the system operates outside of the POS system of the redeeming businesses. As explained further below, for simplicity the system and method are described with reference to various “drinks” as the tangible consumable product but it is expressly noted that any type of consumable product could be used along with any combination of different types of consumable products.

The system would preferably then store the drink redemption data either (1) locally on the smart device memory/storage, (2) on the server memory, or (3) both (1) and (2). The redemption data can include but is not limited to: venue information, drink information, day/time information, age of user, sex of user, and employee information. In some embodiment, ratings and feedback from the user regarding the drink and/or the business offering the redemption can be accepted and stored. All of this data can later be used to provide valuable analytics to the businesses providing redemptions, especially because the data is not heavily skewed by the price bias. In some embodiments, once the user is engaged for a redemption, the system can prompt for a donation to a charity, a tip to the employee, or even making a further purchase from the business.

As shown, once the user redeems a drink, the system timer will reset so that the user cannot obtain another drink redemption that day, and this can be referred to herein as the lockout period. This can be done in a number of ways such as (1) a 12-24 hour lockout period after a redemption or (2) locking the user out of a further redemption until early the next day (i.e. 5:00 am). In some embodiments, a session may be defined which would general represent the business hours of the businesses on the system. A session could then be, for example, 10 am-3 am each day, or could vary with different times for weekdays vs. weekends. In this method, the system would allow one redemption per session, and if the user has already redeemed a drink for the present session, the lockout period is instituted until the next session begins.

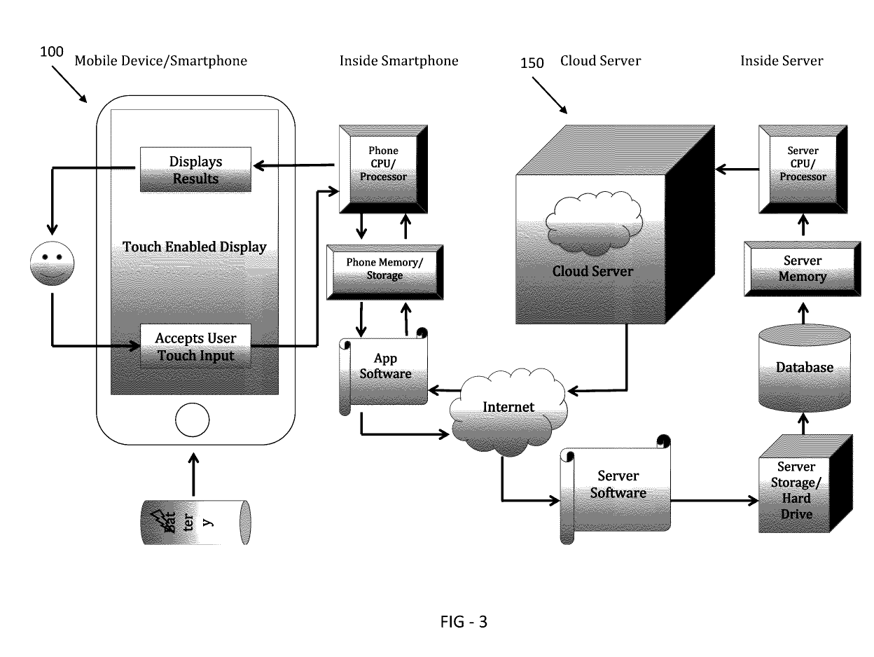

FIG. 3 is block diagram showing how data and logic would flow through the various components of an exemplary embodiment using a mobile smart device 100 and a cloud server 150.

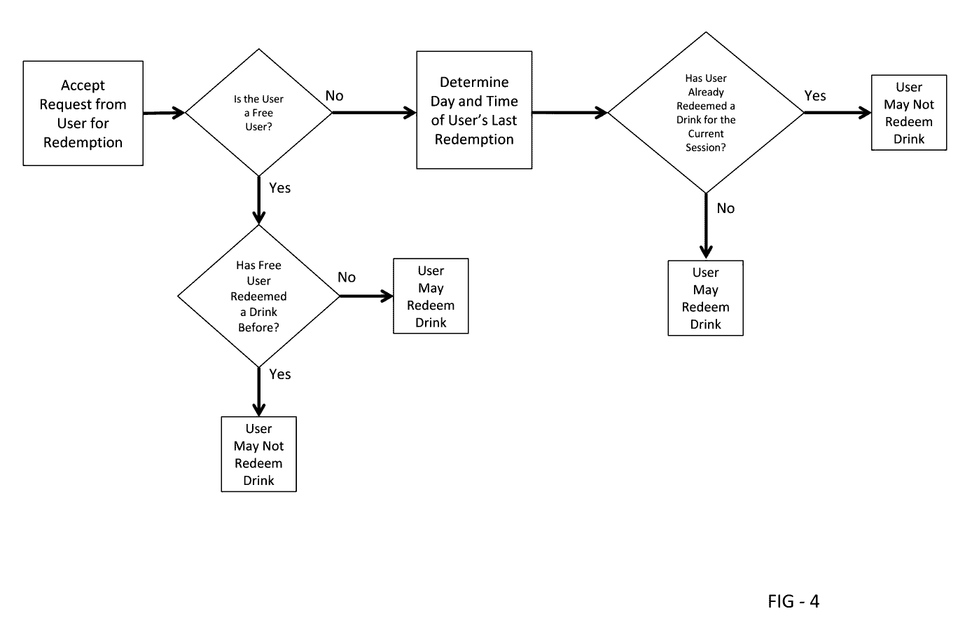

FIG. 4 is a logical flowchart showing how some of the logic within the cloud server 150 would work for an exemplary embodiment. Once the user makes a redemption request, the server 150 would determine if the user is a free user, and if so, only provide a redemption if the user has not previously exhausted the limit for free or trial users. Here, the limit for free users is one drink redemption. If the user is not a free user, then the server 150 would determine the date and time of the user's prior redemption. If the user has already had a redemption for this session (i.e. inside the lockout period), then the request for a redemption is denied. If the user has not already had a redemption for this session (i.e. is not in the lockout period), then the user may redeem the drink.

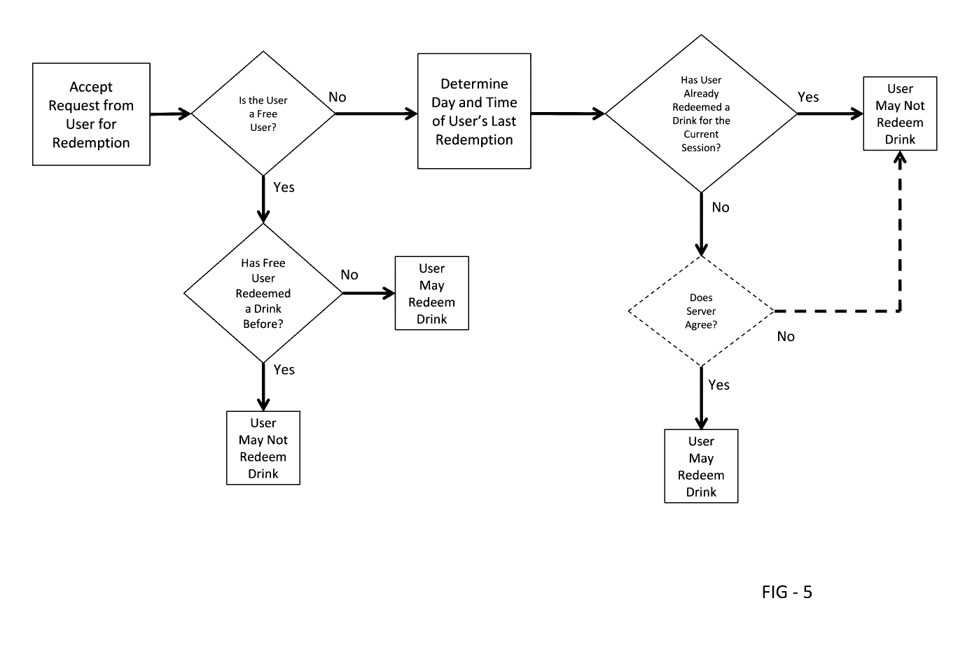

FIG. 5 is a logical flowchart showing how the logic within the mobile device 100 would work for an exemplary embodiment. Here, the logic performed is very similar to the logic shown and described above for the server 150. The logic could be performed at only one device (i.e. the server 150 or mobile device 100 only) or could be performed simultaneously on both devices. In the latter, the mobile device 100 would check with the server 150 to see if they logically agreed to allow the user to redeem the drink. This method provides a backup redundancy in case either the server 150 or the mobile device 100 were hacked to provide unlimited redemptions for possibly no subscription fees.

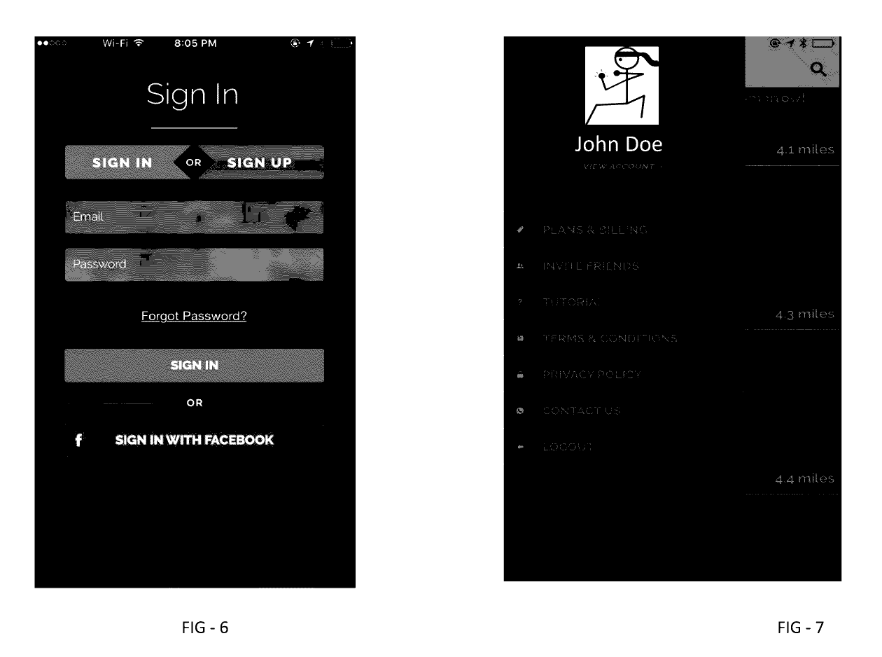

FIG. 6 is a screen shot from a mobile smart device 100 showing a login page.

FIG. 7 is a screen shot from a mobile smart device 100 showing a profile page.

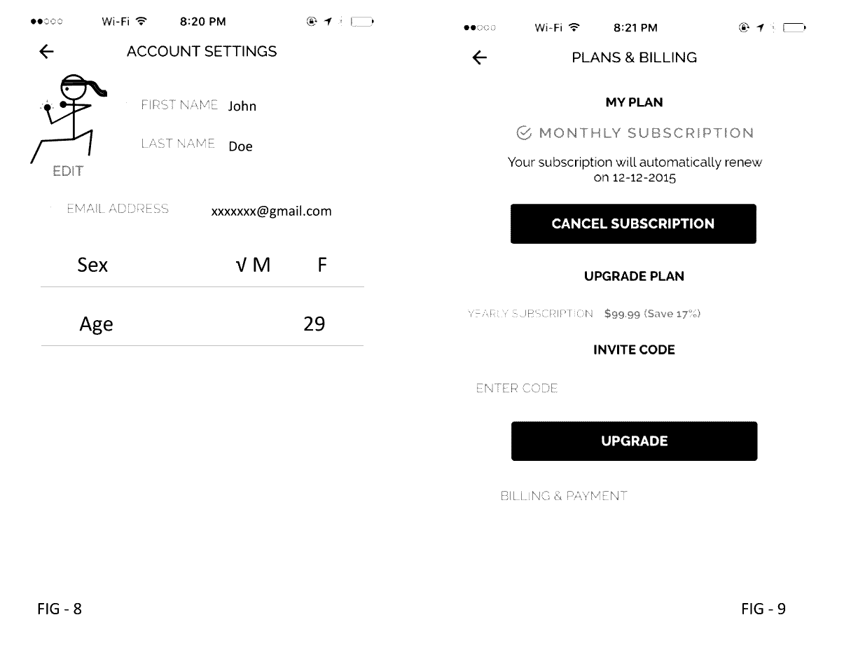

FIG. 8 is a screen shot from a mobile smart device 100 showing an account settings page.

FIG. 9 is a screen shot from a mobile smart device 100 showing a plan and billing information page. The user can pay a monthly subscription fee or an annual subscription fee (which provides an overall discount compared to 12 monthly subscription fees). This screen also provides a way to upgrade from monthly to annual payments or to enter an invite code which would permit a subscription or redemptions without payment.

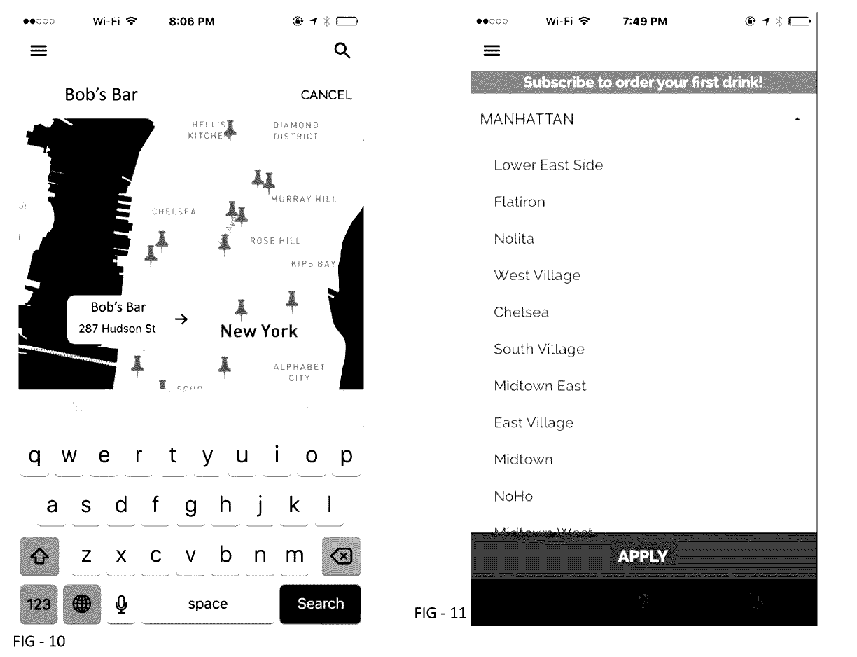

FIG. 10 is a screen shot from a mobile smart device 100 showing a location searching page. Either the name of the business or the address of the business could be searched by the system. Also, a touch-interactive map is provided which will allow a user to choose a business for a redemption based on its location on the map.

FIG. 11 is a screen shot from a mobile smart device 100 showing a neighborhood geographical drop down menu page.

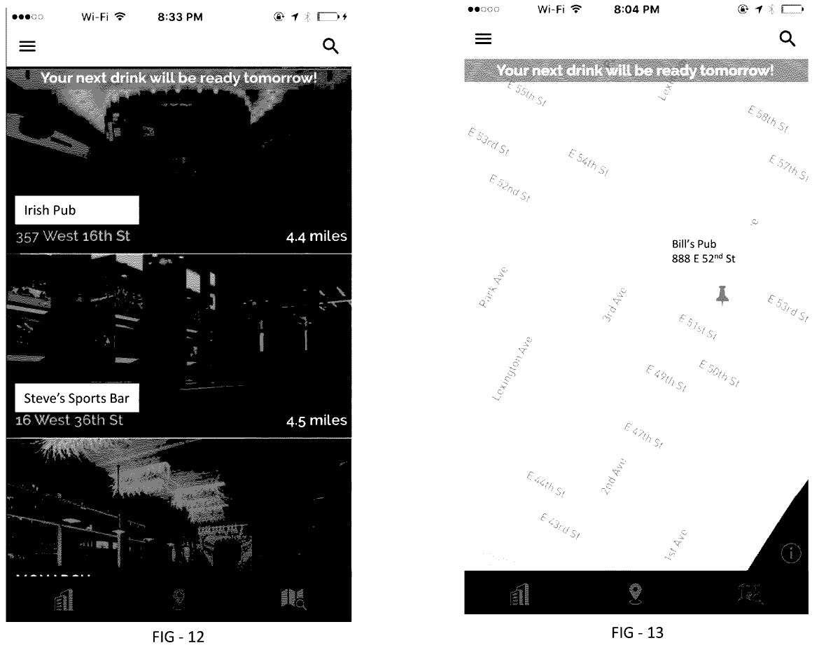

FIG. 12 is a screen shot from a mobile smart device 100 showing a venue search page post subscription and redemption. As shown, the system indicates to the user that the next redemption (drink) will be available tomorrow.

FIG. 13 is a screen shot from a mobile smart device 100 showing a map view after redemption. Again as shown, the system indicates to the user that the next redemption (drink) will be available tomorrow.

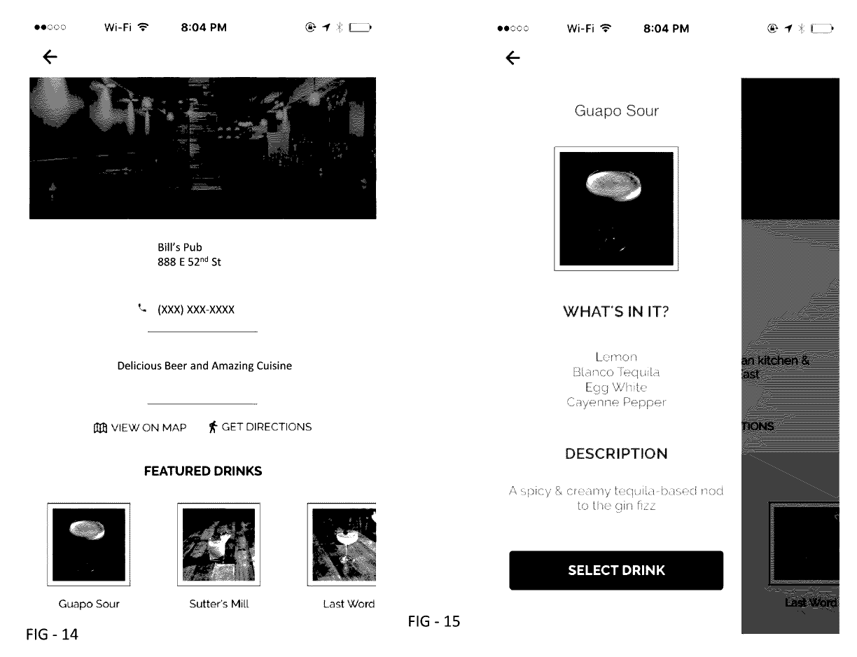

FIG. 14 is a screen shot from a mobile smart device 100 showing a venue page. Here, the user can see the products offered for redemption at the business. In this embodiment, several cocktails are offered for redemption: Guapo Sour, Sutter's Mill, and Last Word (including others which can be seen by sliding the images horizontally).

FIG. 15 is a screen shot from a mobile smart device 100 showing a sample drink description for a selected product for redemption: Guapo Sour.

FIG. 16 is a screen shot from a mobile smart device 100 showing a drink which has been selected for redemption.

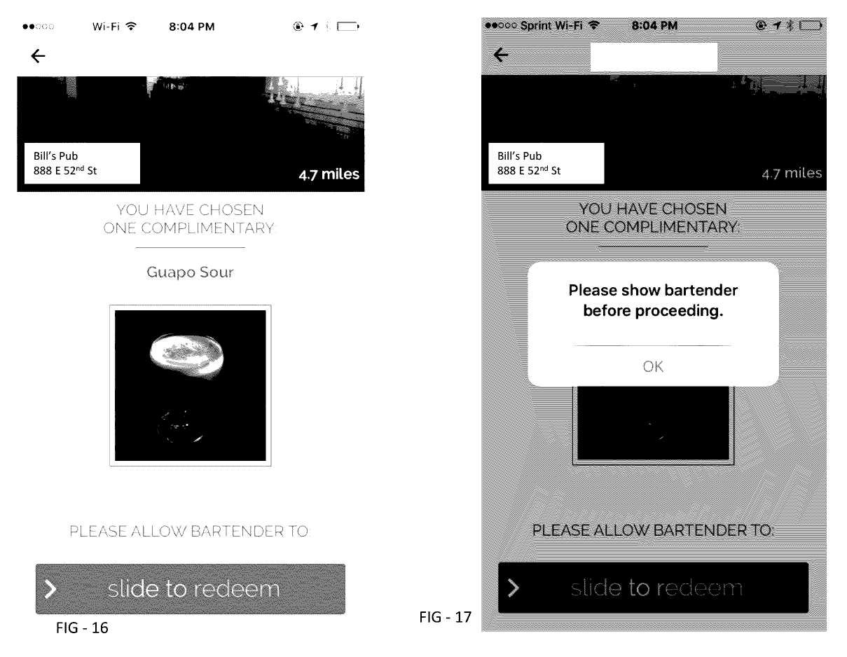

FIG. 17 is a screen shot from a mobile smart device 100 showing the employee prompt page after a drink has been selected for redemption by the user.

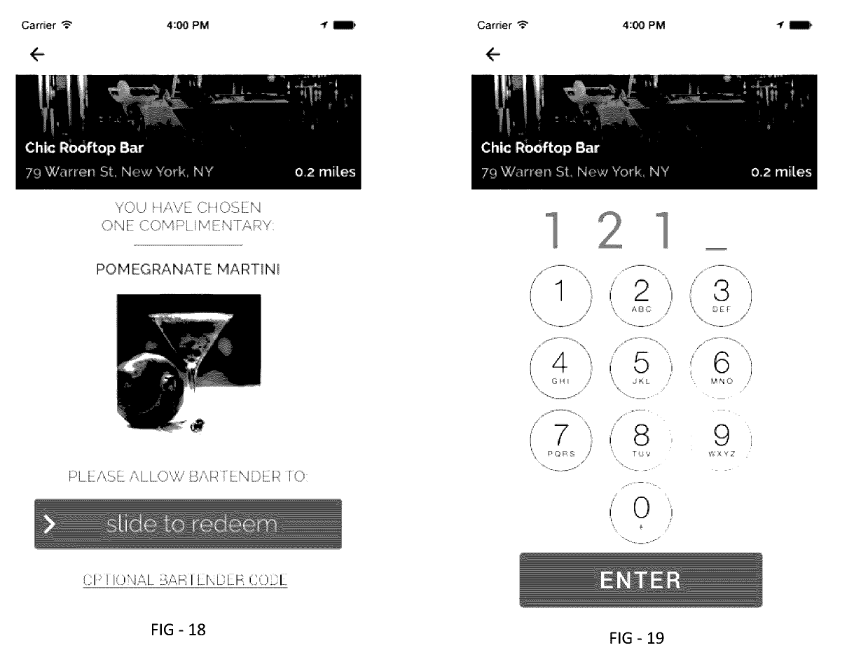

FIG. 18 is a screen shot from a mobile smart device 100 showing the employee prompt page when using the optional employee code.

FIG. 19 is a screen shot from a mobile smart device 100 where the employee is entering the employee code in order to redeem the product (drink) for the user.

FIG. 20 is a screen shot from a mobile smart device 100 showing the redemption page after the employee accepts the redemption request.

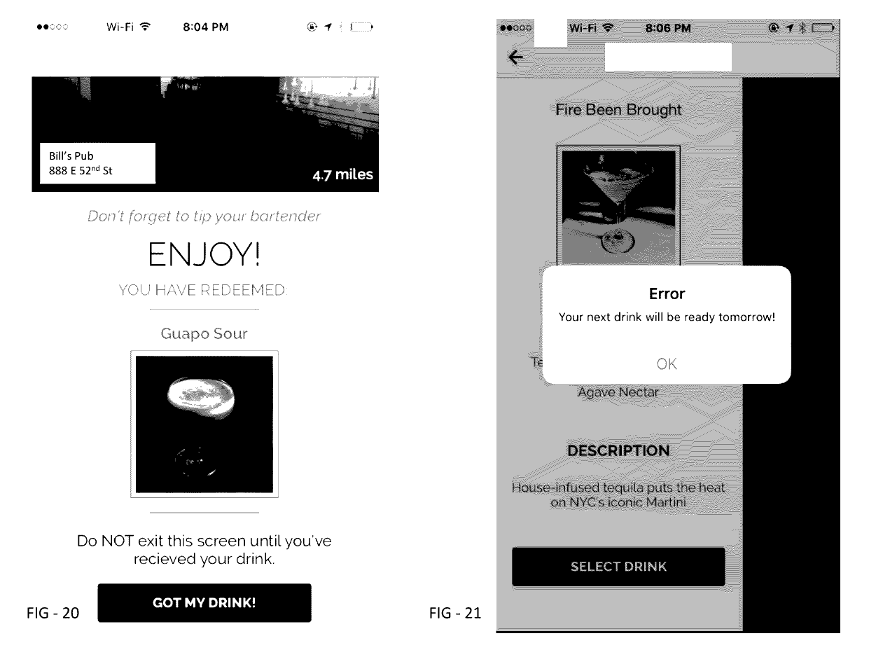

FIG. 21 is a screen shot from a mobile smart device 100 where the user has requested a second drink within the same session, or during the lockout period.

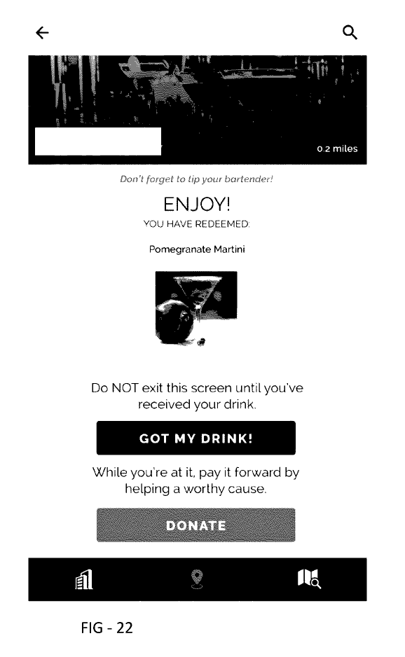

FIG. 22 is a screen shot from a mobile device 100 showing another redemption page after the employee has accepted the redemption request, here with the option of donating.

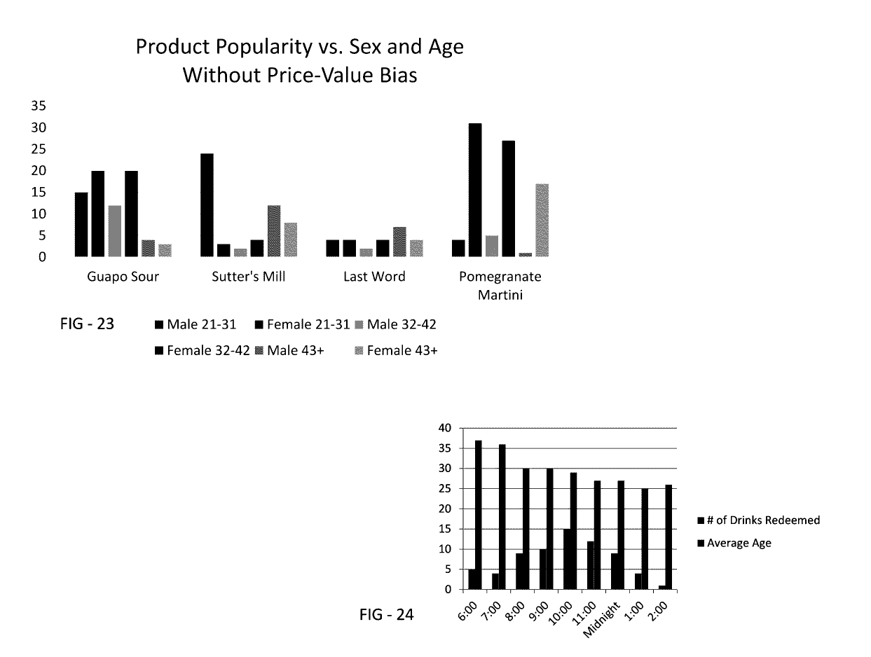

FIG. 23 is a graphical representation of the redemption data showing the popularity of various products based on sex and age of the customer and without price bias. The system is able to track the sex and age of the user as well as each of their redemptions to determine preferences without being affected by the price bias. This is very valuable to the business owners for determining the true preferences of their customers without the noise of this bias, which generally is very hard or impossible to remove. Further, the system can also provide redemptions for various types of consumable products, for example food can be redeemed as well as drinks. In this way, the demographics of the users can be further analyzed and used by the business to target their customers effectively. The overall system can also track which businesses are preferred by the users, and could thus help determine which businesses truly appear to have better products or service, without the price bias.

As indicated further below, the businesses have various types of marketing strategies that were not available previously. In the exemplary embodiments herein, a business can only offer a certain product for redemption, and this product may be offered only on certain days. Thus, a business owner that is struggling with engagement of a particular demographic or on a particular day of the week can now focus marketing efforts directly on these areas of concern. Up front money does not have to be spent by the business in order to increase foot traffic in their facilities, as it can now simply be paid as each user comes in to the business asking for a redemption, although this is not paid in cash but instead in products, which is more appealing to most business owners. In a stark contrast to other types of marketing systems, the embodiments herein allow the business owner to directly track the level of engagement and how much impact each redemption program is having.

FIG. 24 is a graphical representation of the redemption data combined with user data showing the number of products redeemed during each hour of the day along with the average age of users redeeming a product during each hour of the day. This provides a powerful tool for business owners as they can now get very accurate data regarding the activity of their customers and their most-active times as well as the age groups that are most active during that time without heavy price bias. This allows them to adjust their product offerings, advertisements, and even staffing to run their business more efficiently and effectively. As shown above in the user data screen shot, the system can also gather the sex of the user and this data can be charted along with the relevant activity levels shown in this figure.

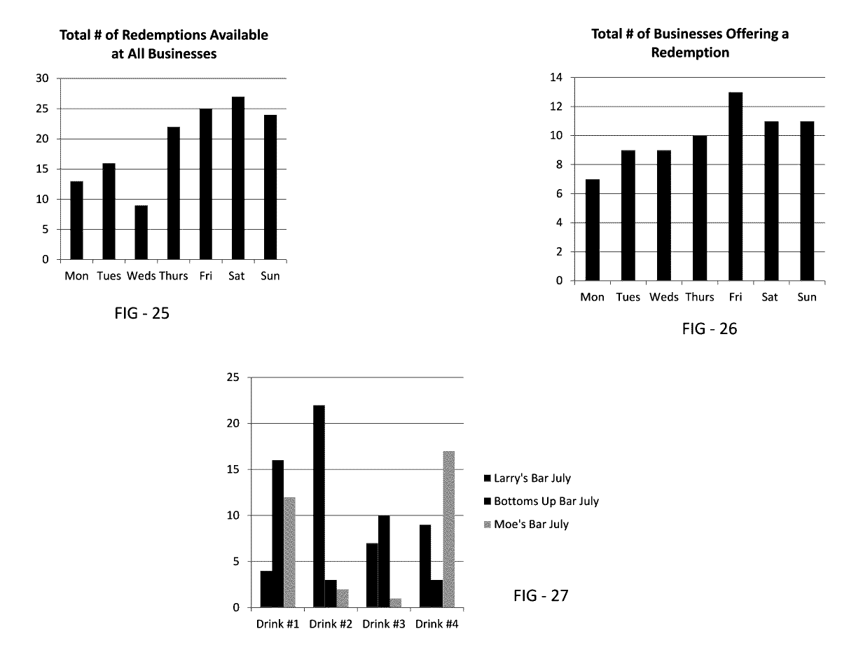

FIG. 25 is a graphical representation of the redemption data showing the total number of available redemptions at all businesses depending on the day of the week. Here, the system allows the administrator, a participating business, or other person to view the total number of redeemable products available at all businesses depending on the day of the week. As shown, the system permits business to offer a different lineup of products for redemption depending on the day of the week.

FIG. 26 is a graphical representation of the redemption data showing the total number of business that are offering redeemable products depending on day of the week. Here, the system allows the administrator, a participating business, or other person to view the total number of participating businesses depending on the day of the week. As shown, the system permits a different number of businesses for product redemption depending on the day of the week.

FIG. 27 is a graphical representation of the redemption data showing the number of drink redemptions per drink number at each bar during the month of July. Here, the administrator or a business can track which drinks were redeemed the most at which business. Here, each business would offer the same four products for redemption (here Drinks #1-#4) and it can be determined which were the most popular with users while removing the bulk of the price bias. This allows a business owner to tailor their offerings and learn about which products their customers prefer to have redeemed. It allows a direct comparison with other competing businesses, which also permits the business owner to select which products should be redeemed (or not redeemed) based on popularity or market factors.

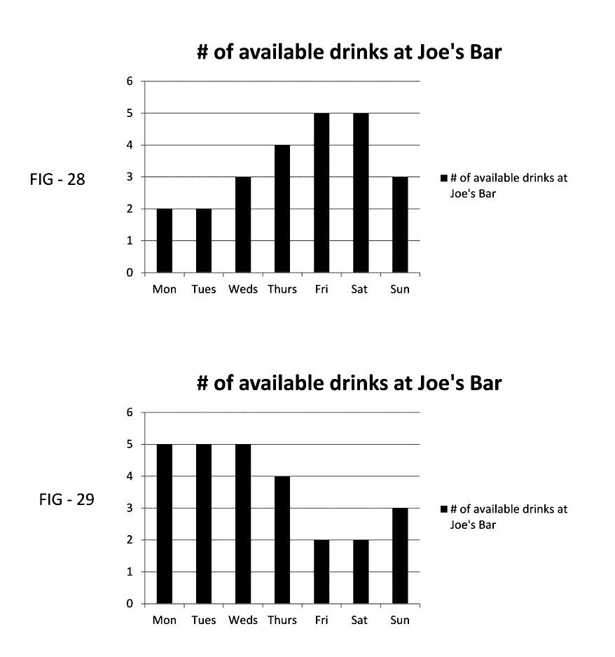

FIG. 28 is a graphical representation of the redemption data showing the number of available products at Joe's bar depending on the day of the week when using a first time based product redemption system model. Here, the venue is using a model which provides more available product redemptions during the traditionally busier days, considering that more users will likely want to request a redemption on these days. Here, the venue owner is working within the given customer traffic to provide a redemption system that works within the given customer traffic.

FIG. 29 is a graphical representation of the redemption data showing the number of available products at Joe's bar depending on the day of the week when using a second time based product redemption system model. Here, the venue is using a model which provides more available product redemptions during the traditionally slower days, considering that it might be easier to increase customer traffic on the slower days by offering more available product redemptions on those days. Here, the venue owner is working against the given customer traffic to hopefully increase the customer traffic on slower days.

It should be noted that the exemplary system and method has sometimes been shown and described above with reference to a drink as the consumable good, but it should be expressly recognized that the exemplary system and method can be practiced with any consumable good, including but not limited to various types of drinks (alcoholic, non-alcoholic, smoothies, juices, coffee, etc.), food goods, either full meals or snacks, or other goods that would be consumed in a relatively short amount of time after purchase. Systems can be focused on only a single type of good or could be offered for any mix of consumables, either food and/or drink.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

We claim:

1. A method for providing electronic product redemption approvals to produce sales analytics data without price bias comprising the steps of:
accepting a subscription payment from a user's smart device at a cloud based server;
electronically providing the user with a plurality of tangible consumable products available from a plurality of businesses for redemption on the user's smart device within a present session;
accepting an electronic redemption request from the user for a specific tangible consumable product redemption from a specific business;
accepting an electronic approval for the electronic redemption request from an employee of the business selected for product redemption, indicating that the employee will provide the user with the requested tangible consumable product free of charge; and
storing the redemption data at the cloud based server to produce sales analytics data without price bias.

2. The method of claim 1 wherein:
the step of accepting an electronic approval for the electronic redemption request is performed without use of a point of sale system of the business.

3. The method of claim 1 further comprising the steps of:
accepting an electronic redemption request from the user's smart device for a second specific tangible consumable product redemption from a specific business; and
transmitting a message to the user's smart device indicating a denial of the electronic redemption request.

4. The method of claim 1 further comprising the steps of:
accepting age and sex data from the user when accepting the subscription payment; and
incorporating age and sex data from the user into the sales analytics.

5. The method of claim 1 wherein:
the step of accepting an electronic approval for the electronic redemption request comprises accepting a numerical code from an employee of the business selected for redemption.

6. The method of claim 1 wherein:
the business selected for redemption does not receive any of the subscription payment.

7. The method of claim 1 wherein:
only one electronic redemption request from the user's smart phone is approved during each session.

8. The method of claim 1 wherein:
the step of accepting the electronic redemption request from the user is performed simultaneously at both the cloud server and the user's smart device.

9. A method for providing electronic product redemption approvals to produce sales analytics data without price bias comprising the steps of:
accepting a subscription payment from a user's smart device at a cloud based server which is operated by a third party;
electronically providing the user with a user interface offering a plurality of products available from a plurality of businesses for only a single redemption during each business day where a redemption allows the user to receive the product from a redeeming business for no charge;
accepting an electronic redemption request from the user for a specific product redemption from a specific business;
accepting an electronic approval for the electronic redemption request from an employee of the business selected for product redemption;
storing the redemption data at the cloud based server to produce sales analytics data without price bias;
accepting an electronic redemption request from the user's smart device for a second specific product redemption from a specific business within the same business day; and
providing a message to the user's smart device indicating a denial of the electronic redemption request.

10. The method of claim 9 wherein:
the step of accepting an electronic approval for the electronic redemption request is performed without use of a point of sale system of the business.

11. The method of claim 9 further comprising the steps of:
providing a message to the user's smart device when the subscription has expired;
providing a message to the user's smart device indicating a denial of any redemption requests following the expiration of the subscription.

12. The method of claim 9 further comprising the steps of:
accepting an electronic redemption request from the user for a specific product redemption from a specific business during the next business day;
accepting an electronic approval for the electronic redemption request from an employee of the business selected for product redemption;
storing the redemption data at the cloud based server to produce additional sales analytics data without price bias;
accepting an electronic redemption request from the user's smart device for a second specific product redemption from a specific business also within the next business day; and
providing a message to the user's smart device indicating a denial of the electronic redemption request.

13. The method of claim 9 wherein:
the products offered for redemption are consumable products.

14. The method of claim 9 wherein:
the subscription payment is received only by the third party, which is different from the businesses offering the product redemptions.

15. The method of claim 9 wherein:
the sales analytics data without price bias includes the quantity of each product that was redeemed during each business day.

16. The method of claim 9 further comprising the steps of:
storing user review data at the cloud server after the product has been redeemed.

17. A system for providing electronic product redemption approvals to produce sales analytics without price bias comprising the steps of
a cloud server configured to accept a subscription payment from a user;
a smart mobile device configured to
present the user with a plurality of products available for redemption within a given session, where the redemption is provided for free by a business which is separate from the third party and does not receive any portion of the subscription payment from the user,
accept an electronic redemption request from the user for a specific product redemption from a specific business,
accept an electronic approval for the electronic redemption request from an employee of the business selected for product redemption, and
produce and transmit redemption data to the cloud based server which includes sales analytics data without price bias.

18. The system of claim 17 wherein:
the cloud server and smart mobile device do not communicate electronically with a point of sale system for the businesses offering the product redemptions.

19. The system of claim 17 wherein:
the smart phone is further configured to deny any electronic redemption request when an electronic redemption request has already been accepted during the same business day.

20. The system of claim 17 wherein:
the product redemption is the act of providing a consumable product free of charge to a user.
